(19) United States
(12) Patent Application Publication
(10) Pub. No.: US 2023/0112169 A1
(43) Pub. Date: Apr. 13, 2023

(54) ESTIMATING OPTICAL PROPERTIES OF A SCATTERING MEDIUM

(71) Applicants: CARMEL HAIFA UNIVERSITY ECONOMIC CORPORATION LTD., Haifa (IL); RAMOT AT TEL-AVIV UNIVERSITY LTD., Tel Aviv (IL)

(72) Inventors: Yael BEKERMAN, Tel-Aviv (IL); Shai AVIDAN, Tel-Aviv (IL); Tali TREIBITZ, Beer Yaacov (IL)

(21) Appl. No.: 17/913,544

(22) PCT Filed: Mar. 22, 2021
(86) PCT No.: PCT/IL2021/050320

§ 371 Date: Sep. 22, 2022

Related U.S. Application Data
(60) Provisional application No. 62/993,148, filed on Mar. 23, 2020.

(51) Int. Cl. G06T 7/90; G01N 21/31

(52) U.S. Cl. CPC G06T 7/90; G01N 21/31; G06T 2207/10024

(57) ABSTRACT

A method of estimating attenuation coefficient ratios from digital image acquired in a scattering medium is disclosed. The method may include, receiving a digital image acquired in a scattering medium; and estimating the attenuation coefficient ratios directly from the digital image. Further is disclosed a method of estimating veiling light values. The method may include receiving a digital image acquired in a scattering medium; and estimating the veiling light value directly from pixels in the digital image associated with objects.

### CROSS-REFERENCE TO RELATED APPLICATIONS

This application claims the benefit of priority of U.S. Provisional Patent Application No. 62/993,148, titled “ESTIMATING OPTICAL PROPERTIES IN UNDERWATER IMAGING”, filed Mar. 23, 2020, the contents of which are incorporated herein by reference in their entirety.

### FIELD OF INVENTION

The present invention generally relates to the field of computer imaging in a scattering medium. More specifically the present invention relates to estimating optical properties of a scattering medium from digital images.

### BACKGROUND OF THE INVENTION

Physics-based underwater image recovery is an ill-posed problem that is typically separated into two parts: estimating the water properties and using a prior to estimate transmission. Once these are estimated, the scene is recovered. While there is substantial work about suitable priors, estimating water properties has been relatively neglected. Nevertheless, these parameters have critical influence on the results. There is therefore a need for improved methods of estimating water properties.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

Aspects of the invention may be directed to a method of estimating attenuation coefficient ratios from a digital image acquired in a scattering medium, comprising receiving a digital image acquired in a scattering medium; and estimating the attenuation coefficient ratios directly from the digital image.

In some embodiments, the method may further include restoring the digital image using the estimated attenuation coefficient ratios. In some embodiments, the method may further include determining at least one of: the biological and chemical composition of the scattering medium based on the estimated attenuation coefficient ratios.

In some embodiments, estimating the attenuation coefficient may include: receiving a veiling light value for two or more color-channels; and calculating attenuation coefficient ratios between at least some of the two or more color-channels in the image, based, at least in part, on the received veiling light value. In some embodiments, the digital image comprises at least red, green, and blue (RGB) color channels. In some embodiments, the attenuation coefficient ratios are calculated between a first one of the color-channels and each of the other two color-channels.

In some embodiments, estimating the attenuation coefficient ratios may further include: creating plots based on pixel values of a first one of the color-channels against pixel values of each one of the other color channels, wherein the pixel values are calculated using the received veiling light value; and selecting a slope from each of the plots as an attenuation coefficient ratio between the corresponding plotted color channels, wherein the selected slope represents lines approximations with respect to the plots.

Some embodiments of the invention may be directed to system for estimating attenuation coefficient ratios from digital image acquired in a scattering medium comprising a memory storing thereon instructions to execute the method according to any one of the embodiments disclosed herein above and a processor configured to execute the stored instructions. Some embodiments of the invention may be directed to computer program product comprising a non-transitory computer-readable storage medium having program instructions embodied therewith to execute the method according to any one of the embodiments disclosed herein above.

Aspects of the invention may be directed to a method of estimating the veiling light value from a digital image acquired in a scattering medium, comprising: receiving a digital image of an object acquired in a scattering medium; and estimating the veiling light value directly from pixels in the digital image associated with objects.

In some embodiments, the method may include restoring the digital image using the estimated veiling light. In some embodiments, the method may include determining at least one of: the biological and chemical composition of the scattering medium based on the estimated veiling light value.

In some embodiments, estimating the veiling light value may include: processing at least some of the pixels of the acquired image. In some embodiments, the estimation may be conducted based on at least one processed pixel and the corresponding pixel in the acquired image. In some embodiments, the method may include clustering pixels, from a region in the digital image into one or more clusters, based, at least in part, on pixel intensity levels, such that clustering is conducted to one of: pixels of the acquired image and pixels of the processed image.

Some embodiments of the invention may be directed to system for estimating a veiling light value from digital image acquired in a scattering medium comprising a memory storing thereon instructions to execute the method according to any one of the embodiments disclosed herein above and a processor configured to execute the stored instructions. Some embodiments of the invention may be directed to computer program product comprising a non-transitory computer-readable storage medium having program instructions embodied therewith to execute the method according to any one of the embodiments disclosed herein above.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 shows input underwater images and results of a method according to some embodiments of the invention.

FIG. 2 shows the image formation model of a horizontal line-of-sight (LOS) according to some embodiments of the invention. The sun's illumination is attenuated while it vertically propagates to the scene. Then, light reflected from the object is attenuated on its way to the sensor. Scattering from particles along the LOS contributes an additive component to the image intensity.

FIG. 3A is a flowchart of a method of estimating attenuation coefficient ratios from digital image acquired in a scattering medium according to some embodiments of the invention.

FIG. 3B is a flowchart of a method of estimating the veiling light value from a digital image acquired in a scattering medium according to some embodiments of the invention.

FIG. 4, shows an example for estimating attenuation coefficients according to some embodiments of the invention. [Top] Data distribution in the [ln (I_{B}−V_{B}), ln (I_{G}−V_{G})]plane from image R3272, rotated by 3 different angles (20°, 40°, 60°). [Center] Number of data points for each x-axis value. [Bottom] The calculated score. The angle of θ=400 receives the maximum score and therefore β_{BG} is set to tan (40°)=0.84.

FIG. 5, shows and example for weak contrast in further areas sometimes results in errors when estimating veiling-light from a texture-less background according to some embodiments of the invention. Blue parts indicate the area that was selected as background. Note the wreck's bridge that was mistakenly marked as background (left) as well as the large sand area (right).

FIG. 6 is a block diagram, depicting a computing device which may be included in a system for estimating attenuation coefficient ratios from a digital image acquired in a scattering medium and/or estimating the veiling light value from a digital image acquired in a scattering medium according to some embodiments.

### DETAILED DESCRIPTION OF THE INVENTION

Disclosed herein are a system, method and computer program product for estimating attenuation ratios and/or veiling light value from an image acquired in a scattering medium (e.g., an underwater image) of a scene.

In some embodiments, the present disclosure provides for estimating attenuation coefficients directly from an image acquired in a scattering (e.g., an underwater image), without relying on prior measurements.

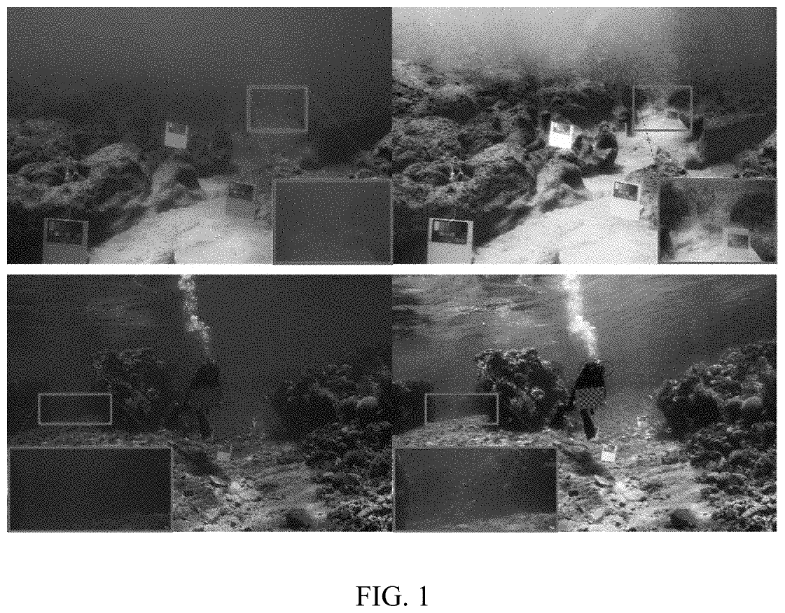

In some embodiments, the estimated attenuation coefficient ratios and/or the estimated veiling light value may allow restoring/correcting the acquired image, as shown in FIG. 1 where the right images are images restored by using the estimated attenuation coefficient ratios and the estimated veiling light value calculated from the left images using method according to embodiments of the invention discloses herein below. In the rectangle frames are zoom-in images of the corresponding portion in the images for better showing the improved contrast of images restored according to embodiments of the invention.

In some embodiments, the estimated attenuation coefficient ratios and/or the estimated veiling light value may further allow determining biological and/or chemical properties of the water, as disclosed and discussed herein below.

In some embodiments, the present disclosure further provides for estimating veiling light value that fits the image formation model to the scene.

In some embodiments, once these ratios are estimated, a standard image dehazing algorithm may be employed to recover the full physical model of the scene that includes the transmission map, depth map, veiling light, and/or the clear image.

The appearance of underwater scenes is highly governed by the optical properties of the water (attenuation and scattering). However, most research effort in physics-based underwater image reconstruction methods is placed on devising image priors for estimating scene transmission, and less on estimating the optical properties. This limits the quality of the results. The present invention focuses on robust estimation of the water properties. In some embodiments, as opposed to previous methods that used fixed values for attenuation, the present invention may estimate attenuation from the color distribution in the image. In some embodiments, the veiling-light color may be estimated from objects in the scene, contrary to looking at background pixels. Thus, some embodiments of the present invention focus on robust estimation of these properties, thereby greatly improving results, especially for distant objects.

The water properties that control the scene appearance are attenuation and scattering. Attenuation coefficients control the exponential decay of light as a function of the traveled distance. The coefficients heavily depend on the wavelength. However, so far this dependency has not been dealt with robustly. In haze this dependency is very small and can be ignored. Many underwater recovery methods stem from dehazing methods and thus often continue with this assumption. Others, that take into account the color dependency, use preset value(s) based on oceanographic measurements. However, using the oceanographic measurements per wavelength in wide-band color channels is erroneous as it does not take into account camera spectral sensitivity, etc. Therefore, some embodiments of the present invention aim to recover the coefficients directly from the image, without using preset values.

Scattering of light in the medium between the object and the camera introduces an additive component to the image. The further the object, there is more intervening medium and thus the scattering increases. The saturation value of this additive component is termed the veiling-light and it occurs when there are no objects in the line-of-sight (LOS). The veiling-light value is assumed constant across the scene and is usually estimated from visible areas in the image that contain no objects. This is not robust enough as often it is difficult to reliably find these areas due to low visibility. In addition, although the veiling-light is treated as a single global value in each scene, in reality it often exhibits non-uniformities. Here uniform illumination is assumed but the veiling-light is not estimated merely based on pixel appearance. Instead, some embodiments of the present invention aim to estimate a robust value that fits the image formation model to the scene.

As use herein a scattering medium is a medium that scatters the light in the LOS. Some examples for shattering mediums are, water, fog, haze, body tissues.

### Underwater Image Formation Model

In some embodiments, at an image acquired in a scattering medium the common underwater image formation describes the scattering medium image (e.g, underwater image) intensity I_{c}(x) at each pixel x and color channel c ∈ R, G, B as follows

I_{c}(x)=t_{c}(x)J_{c}(x)+V_{c}(1−t_{c}(x)) (1)

where J_{c} is the object radiance, V_{c} is the veiling light, and t_{c} is the transmission coefficient.

The image signal I_{c} is an additive combination of the direct signal J_{c} and the veiling-light V_{c}, which carries no information about the scene and therefore degrades the image. The object radiance J_{c} is attenuated by the transmission t_{c}. The global veiling-light V_{c} is the image signal in areas that contain no objects. In some embodiments, the acquired image can be a linear image or a nonlinear image. A linear image would be the first option as this is a physical model, although the inventors surprisingly found that methods according to embodiments of the invention can improve also nonlinear images.

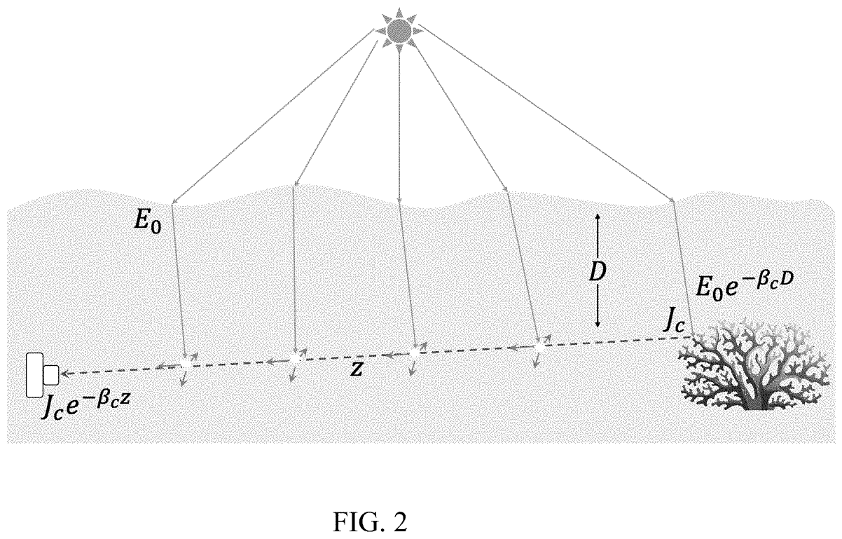

Reference is now made to FIG. 2 which is an illustration of several effects acting in a scattered medium, such as attenuation, scattering, and attenuation of the ambient illumination. Assuming the water medium is homogeneous, the transmission is set by Bouguer's exponential law of attenuation, which is also known as the Beer-Lambert law:

t_{c}(x)=e^{-βcz(x)}, (2)

where β_{c} is the water attenuation coefficient and it is color dependent. Here z(x) is the distance along the line-of-sight (LOS) from the camera sensor to the scene at pixel x. The ratios between the attenuation coefficients may be defined as:

$${β}_{B R} = \frac{{β}_{B}}{{β}_{R}} , {β}_{B G} = \frac{{β}_{B}}{{β}_{G}} \qquad ( 3 )$$

In some embodiments, similarly to horizontal attenuation described in Eq. (2), the vertical propagation of the light from the sea surface to the objects also induces attenuation that depends on the wavelength and the traveled distance. The incident illumination at the surface E₀ is attenuated with depth D, such that the incident illumination on the LOS is E_{c}=e^{-BD}. This results in an illumination color at depth that is different than the sun's illumination at the surface.

In some embodiments, the image formation model in Eq. (1) assumes a horizontal LOS and that E_{C} is uniform in intensity and spectrum across the scene and the LOS, as the objects are located in approximately the same water depth. Thus, this illumination change can be viewed as a global color-cast in the scene.

In some embodiments, the model in Eq. (1) is borrowed from haze and takes only horizontal effects into account. In some embodiments of the present analysis, in order to separate the horizontal and vertical effects the equation may be rewritten as

I_{c}(x)=E_{c}t_{c}(x)\tilde{J}_{c}(x)+E_{c}(1−t_{c}(x))·\tilde{V}_{c}· (4)

So far methods that did not use the form of Eq. (4) actually estimated E_{c}J_{c}, and then compensated for E at the end of their algorithm pipeline by common global white-balance methods. This is physically true as E is a global effect.

However, it was found that this cast may have an effect on the performance of prior-based algorithms as they are based on natural images that do not have a strong color cast. Compensating for the global illumination first, may remove the color cast and aid the prior in identifying the distance-dependent effects better. Therefore, a simple global white balance may be conducted by dividing the pixel values by the maximum in each channel at the beginning of the process. Then, going forward it may be assumed that the global color cast may have been removed, i.e., E_{c}=1, and concentrate on recovering the local distance-dependent effects.

In some embodiments, the haze-lines prior assumes that the colors in a clear image can be clustered to a final set of clusters, and showed that in hazy images these clusters become lines (termed haze lines) in RGB space in the form:

l(x)−V=t(x)[l(x)−V], (5)

where in haze t is assumed to be uniform for all color channels. Based on this observation it may be suggested a dehazing method that clusters the colors into lines after first estimating V. The transmission per pixel may be estimated from the value distribution along each haze-line.

Berman proposed a single image restoration of underwater scenes based on the haze lines prior. In some embodiments, it is showed that if the two global attenuation ratios [β_{RB}, β_{GB}] are known, then Eq. (1) can be rewritten similarly to Eq. (5)

$$[ \begin{matrix}{( {I}_{R} ( x ) - {V}_{R} )}^{{β}_{RB}} \\ {( {I}_{G} ( x ) - {V}_{G} )}^{{β}_{GB}} \\ ( {I}_{B} ( x ) - {V}_{B} ) \\ \end{matrix} ] = {t}_{B} ( x ) \cdot [ \begin{matrix}{( {J}_{R} ( x ) - {V}_{R} )}^{{β}_{RB}} \\ {( {J}_{G} ( x ) - {V}_{G} )}^{{β}_{GB}} \\ ( {J}_{B} ( x ) - {V}_{B} ) \\ \end{matrix} ] . \qquad ( 6 )$$

The form of Eq. (6) matches the image formation model for haze. Then, the haze-line prior can be applied to estimate t_{B}. Once t_{B} is evaluated, the image may be restored according to Eq. (6),

$${J}_{c} ( x ) = \frac{{I}_{c} ( x ) - {V}_{c}}{{{t}_{B} ( x )}^{{β}_{c} / {β}_{B}}} + {V}_{c} , \qquad ( 7 )$$

Previously, [β_{RB}, β_{GB}] were automatically chosen from a fixed set of options, that limited accuracy. In the present invention they can be estimated without prior knowledge.

Accordingly, given either a linear or nonlinear underwater image the goal, in some embodiments, may be to restore the underlying scene to its true colors, i.e., as if there were no water between the camera and the scene. This may require estimation of the attenuation coefficients ratios [β_{BR}, β_{BG}] and/or the veiling light [V_{R}, V_{G}, V_{B}]. The results of all prior-based methods are very sensitive to these values and therefore the method according to some embodiments the present invention focuses on attenuation coefficients ratios and/or veiling light values robust estimation. Once estimated any haze-lines prior can in theory be used for restoration. The haze-lines prior may be used for recovery.

Algorithm 1:

```
      Input I(x) - linear or nonlinear image
      Output J(x) - restored image, t(x) - estimated transmission
            1: Compensating for ambient illumination color ∀_{c}= R, G, B
2: Identify a textureless background area for initial veiling light estimation V and feasible
range.
3: Calculate attenuation coefficients’ ratios [β_{BR}, β_{BG}] according to V using Eq. (8).
4: Find pixels with known ground-truth using a contrast enhanced image.
5: Solve for V using the GT pixels with Eq. (6) by nonlinear least-squares curve fitting
minimization.
6: Calculating [β_{BR}, β_{BG}] using V.
7: Use Haze-Lines prior Eq. (7), with small modifications, to estimate an initial
transmission tB.
8: Regularize transmission using constrained WLS with lower bound constrains.
9: Calculate the restored image using Eq. (7).
10: Convert the restored linear/nonlinear image to sRGB image.
```

### Estimating Ratios of Attenuation Coefficients

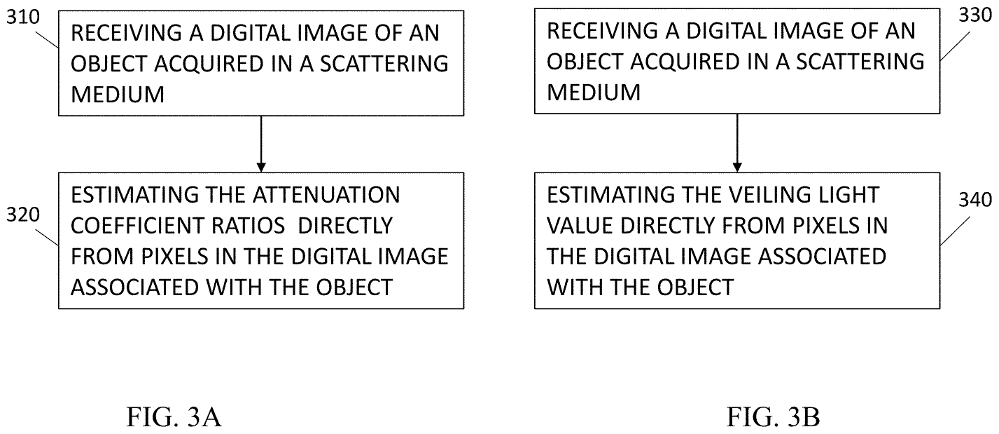

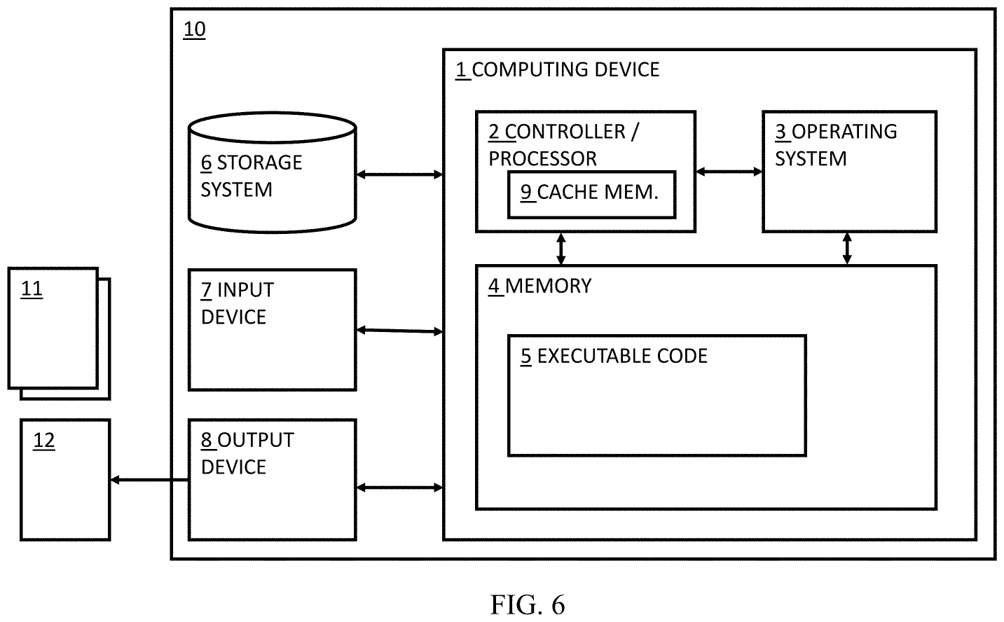

Reference is now made to FIG. 3A which is a flowchart of a method of estimating the attenuation coefficient ratios from a digital image acquired in a scattering medium according to some embodiments of the invention. The method of FIG. 3A may be conducted/executed for example, by a processor such as a processor 2 illustrated and discussed with respect to FIG. 6 or by any other suitable processor. The instructions for executing the method may be stored as a code (e.g., executable code 5) in a memory such as memory 4 illustrated and discussed with respect to FIG. 6.

In step 310, a digital image of an object acquired in a scattering medium may be received. For example, processor 2 may receive at least one of the images in the left side of FIG. 1. In some embodiments, the enquired image may be converted to a linear/nonlinear image as disclosed herein above.

In step 320, the attenuation coefficient ratios may be estimated directly from the digital image.

Contrary to previous methods that used fixed sets of water types the power of embodiments of the present invention may stem from estimating the attenuation coefficient ratios β_{BR}, β_{BG} directly from the image. This may be significantly more accurate as it has been shown that the coefficients depend on the camera sensitivity and other factors, and therefore using pre-defined values as done before results in errors.

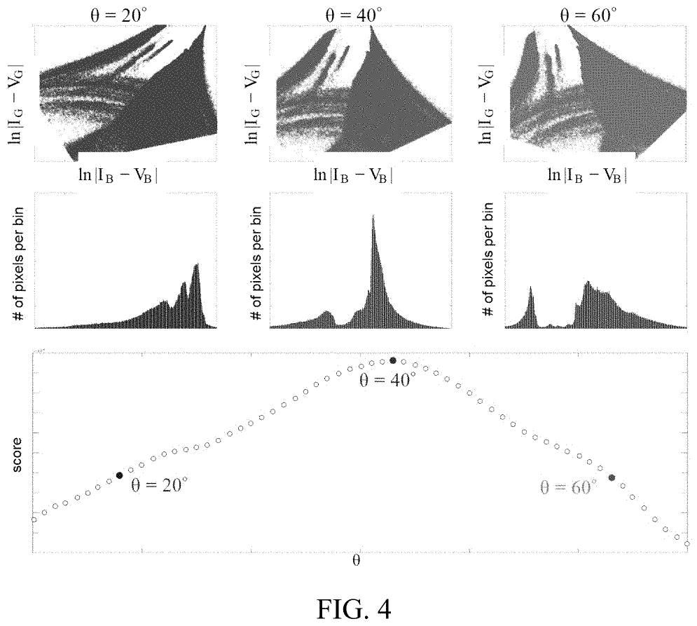

In some embodiments, the approach of the present invention (FIG. 4) stems from Eq. (6). It has been shown that color clusters in a clear image become curved lines in RGB space in underwater images and that knowing β_{BR}, β_{BG} can ‘straighten’ the curves. Thus, the β_{BR}, β_{BG} values that give the best line approximation to the curves are needed.

In some embodiments, estimating the attenuation coefficient may include receiving a veiling light value for two or more color-channels and calculating attenuation coefficient ratios between at least some of the two or more color-channels in the image, based, at least in part, on the received veiling light value. In some embodiments, the veiling light value may be received from a database or estimated according to any embodiment of the invention. For example, it is assumed that the veiling light V is known (e.g., estimated or received) for at least one color channel c (e.g., the digital image may include at least red, green, and blue (RGB) color channels). In some embodiments, the attenuation coefficient ratios may be calculated between a first one of the color-channels and each of the other two color-channels.

Denote L_{c}=ln|I−V_{c}|. Taking the log out of Eq. (6) and rewriting it, shows that L_{c=R,G} is linearly related to L_{B},

$${L}_{c} = {β}_{Bc} {L}_{B} + ln \frac{\vert {J}_{c} - {V}_{c} \vert}{{\vert {J}_{b} - {V}_{B} \vert}^{{β}_{Bc}}} . \qquad ( 8 )$$

In some embodiments, estimating may include creating plots based on pixel values of a first one of the color-channels against pixel values of each one of the other color channels, such that, the pixel values are calculated using the received veiling light value, for example, the slope of the line, in eq. (8) is the unknown β_{BC}, regardless of the object color J_{c} that only affects the line intercept. This insight is used to estimate the coefficients directly out of the image without any a-priori data.

In some embodiments, the method may further include selecting a slope from each of the plots as an attenuation coefficient ratio between the corresponding plotted color channels, such that the selected slope represents lines approximations with respect to the plots. In a nonlimiting example, the values of L_{C=R,G} vs. L_{B} are scatter plotted for all pixels in the image. Then the line slopes that best fit the image data (separately for R and G) are determined. In a nonlimiting example, angles θ ∈ [20°, 70° ] were considered. This range may be chosen as it is physically feasible based on oceanographic data. For each 0 the data is rotated, then the x axis is divided into 500 bins. Each such bin represents a line with angle θ in the original data. In a nonlimiting example, the number of data points in each bin is counted and the top 10% bins with largest values are averaged. This average yields a score for each angle and the angle with the highest score is chosen separately in each of the BG, BR planes.

This estimation yields robustness and the ability to better cope with farther objects. The algorithm steps are summarized in Algorithm 2.

Algorithm 2:
Input I(x)—linear/nonlinear image, V—veiling light
Output ∀_{c} = R, G, B—attenuation coefficients' ratios

| | |
|---|---|
| 1: | for c = R; G do |
| 2: | for V ∈ Ω_{V} do |
| 3: | for each θ ∈ [20⁰; 70⁰]; (u; v) ∈ (L_{c}; L_{B}) do |
| 4: | $[ \begin{matrix}{u}^{′} \\ {v}^{′}\end{matrix} ] = [ \begin{matrix}cos θ & - sin θ \\ sin θ & cos θ\end{matrix} ] \times [ \begin{matrix}u \\ v\end{matrix} ]$ |
| 5: | divide values of u' into 500 bins |
| 6: | binᵥₐₗ = count in each bin |
| 7: | θ_{score} = mean(max 10%(binᵥₐₗ)) |
| 8: | θₘₐₓ = ind(max(θ_{score})) |
| 9: | β_{Bc}[V] = tan(θₘₐₓ) |
| 10: | β_{Bc} = median(θ_{Bc}) |

Implementation details. In some embodiments, it was assumed that for small changes of the veiling light, the attenuation coefficients should not change. Therefore, in order to gain stability, this algorithm was run several times for values around V, Ωᵥ=[V_{c}−0.01: 0.01:V_{c}+0.01] and resulting coefficients Ω_{β}_{_{CB}} were obtained. The same algorithm was run on the GR plane and β_{BR}, β_{BG} were chosen from Ω_{β}_{_{CB}} that minimize∥β_{BR}β_{BG}−β_{GR}∥.

In some embodiments, the digital image may be restored using the estimated attenuation coefficient ratios, as discussed herein above with respect to Algorithm 1. The outcome of s restored images according to embodiments of the invention are presented in the right side of FIG. 1. In some embodiments, processor 2 may send the restored digital image to an external computing device, for example, for further use/analysis. In some embodiments, processor 2 may send the estimated attenuation coefficient ratios to external computing device for further use, by other computer, for example, for determining at least one of: the biological and chemical composition of the scattering medium.

In some embodiments, the method may further include estimating at least one of: the biological and chemical composition of the scattering medium based on the estimated attenuation coefficient ratios. For example, a database (e.g., storage system 6 of FIG. 12) may include correlation information for correlating the attenuation coefficient ratios with chlorophyll levels.

### Veiling-Light Estimation

Reference is now made to FIG. 3B which is a flowchart of a method of estimating the veiling light value from a digital image acquired in a scattering medium according to some embodiments of the invention. The method of FIG. 3B may conducted/executed for example, by processor such as a processor 2 illustrated and discussed with respect to FIG. 6, or by any other suitable processor. The instructions for executing the method may be stored as a code (e.g., executable code 5) in a memory such as memory 4 illustrated and discussed with respect to FIG. 6.

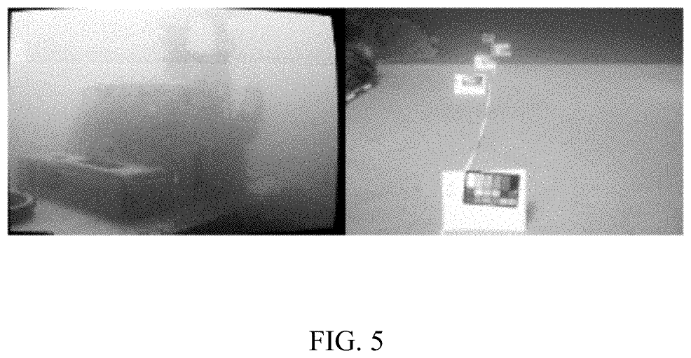

In step 330, a digital image of an object acquired in a scattering medium may be received. For example, processor 2 may receive at least one of the images in the left side of FIG. 1. In some embodiments, the enquired image may be a linear/nonlinear image as disclosed herein above. Estimating the veiling light correctly is important for solving the underwater image formation equation for any dehazing method. The image formation model Eq. (1) assumes a global veiling light for the entire image. However, very often this is not true-the sun is illuminating from an angle, etc. Therefore, methods that find the veiling light using background pixels from the scene are prone to instabilities. Moreover, due to low visibility, the background detection is sometimes erroneous (FIG. 5), inserting errors into the process. To overcome these issues, the veiling-light value that best fits the image formation model based on the given image is needed.

In step 330, the veiling light value may be estimated directly from pixels in the digital image associated with the object. For example, the insight is that a simple contrast stretch recovers the colors of the nearby pixels was used. These pixels may be then used as pixels for which J is known. Using their values in Eq. (1) the missing V value was found using a nonlinear data-fitting minimization.

In some embodiments, the method may further include processing at least some of the pixels in the acquired image. In some embodiments, a global contrast enhancement may be performed on the input image:

$${I}_{c} ( x ) = \frac{{I}_{c} ( x ) - min ( {I}_{c} )}{max ( {I}_{c} ) - min ( {I}_{c} )} . \qquad ( 9 )$$

As should be understood by one skilled in the art other processing methods may be performed on the input image. In some embodiments, processed pixels (e.g., contrast-enhanced pixels), for example, from a region of the digital image may be clustered into one or more clusters, based, at least in part, on pixel intensity levels. Alternatively, pixels, from a region of the input image may be clustered into one or more clusters. In some embodiments, the region is defined with respect to the horizon. For example, the bottom third of the processed image, where it is assumed to be most likely to have nearby objects, may be clustered to P clusters according to intensity levels. For each cluster, each cluster center pixel \hat{x} contributes a data pair [I(\hat{x}), I_{c}(\hat{x})] (e.g., a pixel from the processed images and a corresponding pixel from the acquired image) for the minimization that consists of values from the original image and the processed one.

In some embodiments, the initial guess and boundary conditions were required for the two unknown vectors-the veiling light V and the transmission for each cluster center t_{B}. t_{B} is solved for in the optimization but this value is not used afterwards. The initial estimation for V was done by searching in the upper area of the image for a smooth area, without objects or texture. The pixels in this area were sorted according to their intensity. In a nonlimiting example, the pixel with the mean intensity provides the initial V, the pixel at the 80% percentile the upper bound, and the pixel at the 20% percentile the lower bound. This guess was used to calculate β_{BR}, β_{BG}.

In a nonlimiting example, the transmissions the initial guess was set to be 0.9 as these are nearby objects, and the lower and upper bounds were set to be 0.4 and 1, respectively.

Final Veiling Light Estimation. In some embodiments, the following nonlinear least-squares problem was solved with lower and upper bounds using an iterative curve fitting minimization optimization solver based on trust regions method,

$${min}_{V , {t}_{B}} {\sum }_{p = 1}^{P} \sum {c =}_{R , G , B} {\{ {β}_{Bc} \cdot ln [ \frac{{V}_{c} - {I}_{c} ( p )}{{V}_{B} - {J}_{B} ( i )} ] - ln ( {t}_{B} ( p ) ) \}}^{2} \qquad ( 10 )$$

$$s . t . {V}_{l b} ⩽ V ⩽ {V}_{ub}$$

$$0.4 ⩽ {t}_{B} ⩽ 1$$

In some embodiments, in each iteration V was used for calculating β_{RB},β_{GB} and they were used for calculating the error. The resulting V was used to calculate the final β_{BG}, β_{BR} and together they were used for transmission estimation as further detailed in the specification. The resulting values for t_{B} from Eq. (10) were ignored but were consistent with the assumptions.

In some embodiments, the digital image may be restored using the estimated veiling light value, as discussed herein above with respect to Algorithm 1. The outcome of restored images according to embodiments of the invention are presented in the right side of FIG. 1. In some embodiments, both the estimated veiling light value and the estimated attenuation coefficient ratios may be used for reproducing the digital image. In some embodiments, processor 2 may send the restored digital image to an external computing device, for example, for further use/analysis. In some embodiments, processor 2 may send the estimated veiling light value to external computing device for further use, by other computer, for example, for determining at least one of the biological and chemical composition of the scattering medium.

In some embodiments, the method may further include determining at least one of: the biological and chemical composition of the scattering medium based on the veiling light value. For example, a database (e.g., storage system 6 of FIG. 12) may include correlation information for corelating the veiling light values with chlorophyll values.

### Transmission Estimation and Regularization

In some embodiments, the transmission was estimated based on the haze-line prior. The estimated per-pixel transmission must be regularized to enforce smoothness and overcome noise.

In some embodiments, the present invention uses a constrained weighted linear least-squares problem using an interior-point method. A lower bound was set on the transmission that stems from the constraint J_{c}≥0. This optimization together with the lower bound reduced artifacts and improved results.

In some embodiments, since this optimization adds constraints per pixel, its run time is increased. To overcome this issue the transmission map is down-sampled and iteratively up-sampled back, using an intensity guided depth up-sampling method.

In some embodiments, physics-based image restoration methods require a good prior to recover a clean image, as well as an accurate estimation of the water optical/chemical/biological parameters. While there has been a considerable amount of work on new priors and methods for underwater image restoration, there has been much less work on estimating the water attenuation properties. Most methods simply assumed fixed or preset attenuation values, which limited their ability to recover scene properties.

Embodiment of the present invention is the first to demonstrate a method to robustly estimate both attenuation parameters from the image itself, as well as the veiling-light. It should be noted that the veiling light value estimated with the method best fits the scene and does not rely on finding background pixel values.

In some embodiments, when the recovered attenuation parameters and veiling light are used with an existing image restoration algorithm there is a considerable improvement in the quality of the results. A rigorous evaluation on several datasets show that the method of the present invention performs the best in terms of scene restoration.

In some embodiments, the parameter estimation method discussed hereto is independent of the restoration algorithm and can be used with other physics based image restoration algorithms.

### Experimental Results

An extensive qualitative and quantitative evaluation of the present invention as compared to the prior art was conducted on several datasets. As the present estimation is more robust the method of the current invention provides superior results including on challenging scenes.

Reference is now made to FIG. 6, which is a block diagram depicting a computing device, which may be included within an embodiment of a system for estimating attenuation coefficient ratios from a digital image acquired in a scattering medium and/or estimating the veiling light value from a digital image acquired in a scattering medium, according to some embodiments.

Computing device 12 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task or script. Executable code 5 may be executed by processor or controller 2 possibly under control of operating system 3. For example, executable code 5 may be an application that may estimate attenuation coefficient ratios from a digital image acquired in a scattering medium (e.g., the method of FIG. 3B) and/or estimate the veiling light value from a digital image acquired in a scattering medium (e.g., the method of FIG. 3A) as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data, such as, the correlation between the biological and/or chemical composition of the scattering medium and the veiling light value and/or attenuation coefficient ratios may be stored in storage system 6 and may be loaded from storage system 6 into memory 4 where it may be processed by processor or controller 2. In some embodiments, some of the components shown in FIG. 12 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of estimating attenuation coefficient ratios from a digital image acquired in a scattering medium, comprising:
receiving a digital image acquired in a scattering medium; and
estimating the attenuation coefficient ratios directly from the digital image.

2. The method of claim 1, further comprising: restoring the digital image using the estimated attenuation coefficient ratios.

3. The method of claim 1, further comprising: determining at least one of: the biological and chemical composition of the scattering medium based on the estimated attenuation coefficient ratios.

4. The method according claim 1,
wherein estimating the attenuation coefficient comprises:
receiving a veiling light value for two or more color-channels; and
calculating attenuation coefficient ratios between at least some of the two or more color-channels in the image, based, at least in part, on the received veiling light value.

5. The method of claim 4, wherein the digital image comprises at least red, green, and blue (RGB) color channels.

6. The method of claim 4, wherein the attenuation coefficient ratios are calculated between a first one of the color-channels and each of the other two color-channels.

7. The method according to claim 4, wherein
estimating the attenuation coefficient ratios further comprises:
creating plots based on pixel values of a first one of the color-channels against pixel values of each one of the other color channels, wherein the pixel values are calculated using the received veiling light value; and
selecting a slope from each of the plots as an attenuation coefficient ratio between the corresponding plotted color channels, wherein the selected slope represents lines approximations with respect to the plots.

8. A system for estimating attenuation coefficient ratios from digital image acquired in a scattering medium, comprising:
a memory; and
a processor configured to execute instructions stored on the memory to:
receive a digital image acquired in a scattering medium; and
estimate the attenuation coefficient ratios directly from the digital image.

9. (canceled)

10. A method of estimating the veiling light value from a digital image acquired in a scattering medium, comprising:
receiving a digital image of an object acquired in a scattering medium; and
estimating the veiling light value directly from pixels in the digital image associated with objects.

11. The method of claim 10, further comprising: restoring the digital image using the estimated veiling light.

12. The method of claim 10, further comprising: determining at least one of: the biological and chemical composition of the scattering medium based on the estimated veiling light value.

13. The method according to claim 2, wherein
estimating the veiling light value comprises:
processing at least some of the pixels of the acquired image.

14. The method of claim 13, wherein estimating the veiling light value is based on at least one processed pixel and the corresponding pixel in the acquired image.

15. The method of claim 14, further comprising: clustering pixels, from a region in the digital image into one or more clusters, based, at least in part, on pixel intensity levels, and wherein clustering is conducted to one of: pixels of the acquired image and or pixels of the processed image.

16. (canceled)

17. (canceled)

18. The system according to claim 8 wherein the processor is further configured to restore the digital image using the estimated attenuation coefficient ratios.

19. The system according to claim 8 wherein the processor is further configured to determine at least one of: the biological and chemical composition of the scattering medium based on the estimated attenuation coefficient ratios.

20. The system according to claim 8, wherein estimating the attenuation coefficient comprises:
receiving a veiling light value for two or more color-channels; and
calculating attenuation coefficient ratios between at least some of the two or more color-channels in the image, based, at least in part, on the received veiling light value.

21. The system according to claim 20 wherein the digital image comprises at least red, green, and blue (RGB) color channels.

22. The system according to claim 20 wherein the attenuation coefficient ratios are calculated between a first one of the color-channels and each of the other two color-channels.

23. The system according to claim 20, wherein estimating the attenuation coefficient ratios further comprises:
creating plots based on pixel values of a first one of the color-channels against pixel values of each one of the other color channels, wherein the pixel values are calculated using the received veiling light value; and
selecting a slope from each of the plots as an attenuation coefficient ratio between the corresponding plotted color channels, wherein the selected slope represents lines approximations with respect to the plots.
